(19) United States
(12) Patent Application Publication
(10) Pub. No.: US 2026/0208240 A1
(43) Pub. Date: Jul. 23, 2026

(54) WATER CANNON SYSTEM FOR CLEANING STORAGE TANKS AND METHODS THEREOF

(71) Applicant: Ramon Villarreal, Modesto, CA (US)

(72) Inventor: Ramon Villarreal, Modesto, CA (US)

(21) Appl. No.: 19/035,570

(22) Filed: Jan. 23, 2025

(51) Int. Cl. B08B 9/093

(52) U.S. Cl. CPC B08B 9/0936

(57) ABSTRACT

A water cannon system for cleaning the interior surfaces of storage tanks, particularly wine storage tanks, is disclosed. The water cannon can mount securely to the access door of a storage tank, allowing an operator to control its operation from outside the tank. The system includes a handle connected to the cannon body, which allows the operator to manipulate the position and orientation of the cannon using a handlebar. This eliminates the need for confined space entry while enabling the water cannon to clean hard-to-reach areas of the tank interior.

### FIELD OF THE INVENTION

The present invention relates to a water cannon system for cleaning storage tanks. More particularly, the present invention provides a water cannon operable to clean a plurality of surfaces inside the tank while being operated by an operator standing outside of the tank.

### BACKGROUND OF THE INVENTION

Cleaning wine storage tanks is a critical step in the winemaking process to prevent contamination and preserving the quality of future batches. Residual wine, organic material, and microbial contaminants can compromise the integrity of the wine being produced. Therefore, wine storage tanks require cleaning of interior surfaces to prevent further contamination. Wine storage tanks are often designed with cylindrical or oval structures having an access door accessible by operators. These access doors are positioned at the bottom tank to allow operators access to the inside of the tank. These access doors also provide the watertightness and pressure resistance necessary for the storage of the wine. While these designs optimize wine storage, they pose significant challenges for effective cleaning and sanitation.

Cleaning solutions for wine storage tanks frequently require confined space entry and fail to clean the entire interior surface area of the tank. Confined space entry may expose operators to several health risks or injuries. Specifically, the restricted dimensions and limited ventilation of wine storage tanks can create hazardous working conditions, increasing the likelihood of physical injuries, such as slips, falls, or accidental impacts with internal structures. Additionally, operators may be exposed to harmful cleaning agents, chemical residues, or microbial contaminants within the tank, which can pose health risks over time.

Examples of these devices include fixed-position cleaning devices, free-floating cleaners, and spray apparatuses. Fixed-position cleaning devices allow operators to direct water flow but often fail to clean the entire interior surface of the tank. Free-floating cleaners require operators to physically enter the tank, presenting safety risks. Spray apparatuses can be placed inside the tank but may require manual adjustment or intervention to ensure complete coverage of the tank's surfaces.

Therefore, there exists a need for a cleaning system designed to mount wine storage tanks and clean the inside of the tank without requiring confined space entry.

### SUMMARY OF THE INVENTION

The present invention relates to a water cannon system operable to clean the internal cavity of storage tanks. More specifically, the system offers a mechanical system for cleaning wine storage tanks that are difficult to access internally or pose safety risks to operators. The system provides a water cannon controlled by an operator standing outside of the tank, thereby eliminating confined space entry. The water cannon may be mounted to an access door located outside the tank interior, thereby allowing operators to manipulate the cannon and clean all surfaces inside the tank.

In some embodiments, the storage tank may include wine and beverage storage tanks, industrial process tanks, agricultural storage tanks, environmental and waste storage tanks, and the like. The internal contents of the storage tank may include fluids such as wine, beer, cider, distilled spirits, brine, and dairy products. In particular embodiments, the storage tank may be a container capable of storing fermented liquids such as wine. The tank may have a cylindrical, oval, or other geometry and an access door providing operators access to the internal volume of the tank.

The access portal and door of the tank provide access for cleaning, inspection, and maintenance of the internal cavity of the tank, while maintaining a secure and hygienic seal during storage. The portal, or opening in the tank wall, may be a circular, oval, or rectangular, depending on the shape of the tank and intended use. The access portal may be reinforced with an outwardly extending collar that forms a rigid, structurally stable flange around the opening. This collar provides a flush surface for sealing the door and provides a mounting interface for auxiliary equipment. The collar may include an inner chamfer or groove to accommodate a gasket or O-ring, creating a fluid-tight seal when the door is closed. The access door may be hinged or fully removable, with hinged designs often preferred for ease of operation.

To accommodate auxiliary cleaning systems, such as a water cannon, the portal collar may include provisions for mounting equipment. The collar may be engaged with a slotted support bracket, adjustable clamp, or other mechanism operable to attached to the collar that may allow a water cannon to be securely mounted at the access door. For example, the support bracket may include a slot to engage with the collar of the access door and may accommodate tanks with varying collar sizes through the use of a tightening mechanism (e.g., a bolt) or adapter. This adaptability allows the system to be used with a plurality of tank designs, further extending its utility. The mounted water cannon may be operable to securely access and clean the interior of the tank once anchored to the access portal collar.

The water cannon system may include a dynamic connection at or near the junction of the cannon body and input conduit, enabling the cannon body to pivot and rotate in multiaxial motion at the dynamic joint system. In some embodiments, the dynamic connection may include rotating joints in two axes. The dynamic joint system may be positioned inside the tank when the support bracket is attached to the collar and the water cannon system is installed for use. This dynamic connection allows for smooth and precise adjustments to the orientation of the cannon body, ensuring it can be angled in any direction required to access and clean all surfaces within the tank, including the top, bottom, walls, and hard-to-reach areas such as corners or irregular geometries by manipulation of the handle by the operator.

In some embodiments, the movement of the water cannon allowed by the dynamic joint system inside the tank is provided by two rotating joints on perpendicular axes. The movement allowed by the rotating joints can be conceived in terms of the pitch and roll concepts from aviation. A first joint allows the barrel rotation of the water cannon assembly inside the tank, or roll along a horizontal axis pointing into the tank. A second joint allows for pitch adjustment along a second axis perpendicular to the horizontal axis. The second joint may be connected to and distal to the first joint, such that the second axis rotates with the first joint. The relationship of the first and second joints allows the water cannon to be angled and directed at the entire interior of the tank by rotation of the two joints. This flexibility, combined with the handle's ability to adjust the cannon's angle and depth, allows the operator to direct the water flow toward all areas of the tank, including hard-to-reach corners.

In some embodiments, the first and second joints may be swivel joints or rotary joints linking two fluid conduits while allowing relative rotation between them while maintaining a continuous passage for fluid flow. The joints enable rotational motion along an axis running longitudinal along the conduits without compromising the seal between the conduits or causing water leakage, where one conduit can rotate relative to the other along the axis. The swivel joint may also include a sealing mechanism, such as O-rings or mechanical seals, to ensure a fluid-tight connection during rotation, as well as compatibility with varying water pressures and durability, often achieved through the use of corrosion-resistant materials like stainless steel, brass, or polymer composites.

In some embodiments, one or more of the joints of the dynamic joint system may be a ball joint. The ball joint may allow for smooth and controlled multiaxial movement. A ball joint may enable the cannon to pivot and rotate in any direction, effectively targeting all surfaces within the tank, including the walls, ceiling, base, and hard-to-reach corners. The ball joint may include a socket enclosing a spherical component (the “ball”), the ball being operable to rotate freely while maintaining a secure and sealed connection. In the water cannon system, the ball joint may have a sweep angle in a range of about 45° to about 70°, enabling the operator to direct the cannon's nozzle upward to clean the tank's ceiling, downward to reach the floor, or laterally to cover the walls and corners. This level of flexibility ensures that water can be sprayed in a 360-degree range of motion at a large sweep angle.

The ball joint design may include internal seals, such as O-rings or gaskets that may prevent leaks at high fluid pressure while allowing for unrestricted rotation. By combining the ball joint with a handle outside the tank, operators can intuitively adjust the cannon's position and angle without entering the tank or manually repositioning the system.

The water cannon system may include a handle that allows for the manipulation of the water cannon. The handle of the water cannon system can be connected to the cannon at a point distal to the first and second joints by a movable handle joint that allows controlled movement and rotation of the handle. The handle may include ergonomical hand grips for one or both hands of the operator and an extension (e.g., a rod) that reaches from the handle to the movable joint connecting the extension to the water cannon.

The handle joint may be a universal joint, including two yokes connected by a central cross-shaped component, allowing rotation about two perpendicular axes. This joint permits the handle to move up and down (pitch) and side to side (yaw), making it ideal for systems requiring precise control of multiaxial movement, though it does not allow for axial rotation of the handle around its own axis. By not including axial rotation in the handle joint, the operator can impart rotational torque on the handle to drive rotation of the first joint of the water cannon to adjust the spray of the cannon. In other embodiments, a hinged joint can be used to provide pivotal motion in one axis, such as pitch or yaw, while allowing axial rotation through the first joint of the water cannon system, making it a simple yet robust solution. In other embodiments, a flexible coupling such as a spring joint can offer limited multiaxial movement through the elasticity of its materials, absorbing shocks or vibrations but providing less precision and range than other joint types.

The handle extension is designed to extend outward from the cannon body at an ergonomically favorable length and angle, ensuring that an operator can comfortably grip and control it from a safe position outside the tank. The handle may have a length that allows it to fully extend the water cannon to a horizontal pitch while the operator manipulating the handle does not cross the threshold of the access portal with their hands or any other portion of their body. In some embodiments, the handle may allow the operator to rotate the cannon on two axes—through rotation of the first and second joints—to adjust the barrel rotation and pitch of the water cannon by applying controlled torque. This rotation enables the cannon to direct water flow upward to reach the tank's ceiling, downward to clean the base, horizontally around the circumference of the tank, and across the curved or flat walls. The handle may further include an adjustable locking feature that allows the operator to temporarily fix the cannon at a desired angle for steady cleaning of a specific area.

The design of the dynamic joint system and handle allows for operator to perform all adjustments to the position of the cannon without any part of the operator's body crossing the threshold of the access door. By allowing the operator to manipulate the cannon entirely from outside the tank, the system improves safety by eliminating the risk of injury associated with confined space entry.

The water cannon may include an input conduit to receive water from an external water source, such as a pump or reservoir, and an output nozzle that sprays water inside the tank. The input conduit may be in fluid communication with the first joint of the cannon system, and is operable to deliver fluid to the cannon system through the first joint. The water flow may be adjusted in terms of speed, pressure, and spray pattern for a plurality of cleaning applications. The nozzle may be equipped with interchangeable tips and mechanisms to produce diverse spray patterns, including focused jets, fan sprays, and rotating sprays, ensuring effective cleaning of residues and contaminants.

Materials for the water cannon may be used to withstand high-pressure water flow, acidic or alkaline cleaning agents, and prolonged use. Some examples of materials may include durable, corrosion-resistant materials such as stainless steel, brass, polymer materials (e.g., PTFE), or composite materials. These materials are non-reactive with residues in the tank (e.g., wine residue) or cleaning solutions, preventing contamination of future wine batches.

In operation, the water cannon directs water toward the tank's base, walls, and other internal surfaces through intuitive control of the handle. Operators may push, pull, or rotate the handle to adjust the cannon's position and angle, enabling targeted cleaning without requiring manual repositioning of the system. By mounting the water cannon to the access door, operators may clean the tank thoroughly while minimizing the risk of injury in entering a confined space. For example, an operator may tilt the handle upward to angle the cannon toward the tank's top surfaces, or rotate the handle laterally to direct water flow along the curved walls. This level of control ensures comprehensive cleaning of the tank's interior, even for areas that are typically challenging to access.

In summary, the present invention may provide a versatile, efficient, and safe solution for cleaning storage tanks, particularly those used in wine production, ensuring compliance with hygiene standards and enhancing overall productivity.

It is an aspect of the present invention to provide a water cannon for cleaning a storage tank having a support bracket operable to engage with an access door of the storage tank; an input conduit operable to receive water from an external water source; a cannon body having a pair of converging conduits terminating into an output nozzle operable to direct a flow of water; a connection mechanism positioned in between the input conduit and the cannon body, wherein the connection mechanism is operable to swivel; and a handle connected to the cannon body, wherein an operator remains outside of the access door of the storage tank while also manipulating the handle to direct the output nozzle towards a plurality of surfaces inside a cavity of the storage tank.

It is an aspect of the present invention to provide a method for cleaning a storage tank, where the method provides a water cannon having an input conduit, a support bracket, a cannon body having a pair of converging conduits, a connection mechanism positioned in between the input conduit and cannon body, a handle having a connecting shaft connected to a securing bracket, an output nozzle extending from the converging conduits, and a support bracket having a slot and an adjustment mechanism; providing a storage tank having an access door and an interior cavity having a plurality of surfaces; loosening the adjustment mechanism on the support bracket; engaging the access door with the slot of the support bracket; tightening the adjustment mechanism on the support bracket; connecting the external water source to the input conduit; releasing the water from the output nozzle; manipulating the handle to swivel the cannon body about an axis relative to the access door to clean a plurality of surfaces in the internal cavity.

It is an aspect of the present invention to provide a system for cleaning a storage tank, where the system includes a water cannon having an input conduit, a support backet having a slot and an adjustment mechanism, a cannon body having a pair of converging conduits terminating into an output nozzle operable to direct water flow, a connection mechanism positioned in between the input conduit and the cannon body, a handle having a connecting shaft extending from a securing bracket, where the handle is positioned outside of an access door of the storage tank. The slot of the support bracket engages with an access door and an operator standing outside of the access door can manipulate the handlebar to move the cannon body to swivel the cannon body about an axis perpendicular to a plane of the access door to clean a plurality of surfaces in the internal cavity of the storage tank where the plane is a flat surface extending across a perimeter of the access door.

Further aspects and embodiments will be apparent to those having skill in the art from the description and disclosure provided herein.

It is an object of the present invention to provide a water cannon system operable to protect operators from injury.

It is an object of the present invention to provide a water cannon system operable to clean the entire interior surface area of the storage tank.

It is an object of the present invention to provide a water cannon having an ergonomic handle allowing operators to manipulate water flow from outside the tank.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of a water cannon, according to an embodiment of the present invention.

FIG. 2 provides a top view of a water cannon, according to an embodiment of the present invention.

FIG. 3 provides a bottom view of a water cannon, according to an embodiment of the present invention.

FIG. 4 provides a first side view of a water cannon, according to an embodiment of the present invention.

FIG. 5 provides a second side view of a water cannon, according to an embodiment of the present invention.

FIG. 6 provides a front view of a water cannon, according to an embodiment of the present invention.

FIG. 7 provides a rear view of a water cannon, according to an embodiment of the present invention.

FIG. 8 provides an environmental view of a water cannon, according to an embodiment of the present invention.

FIG. 9 provides a second environmental view of a water cannon, according to an embodiment of the present invention.

FIG. 10 provides a third environmental view of a water cannon, according to an embodiment of the present invention.

FIG. 11A provides a second perspective view of a water cannon, according to an embodiment of the present invention.

FIG. 11B provides a third perspective view of a water cannon, according to an embodiment of the present invention.

FIG. 12 provides a fourth environmental view of a water cannon, according to an embodiment of the present invention.

FIG. 13 provides an additional view of a water cannon, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

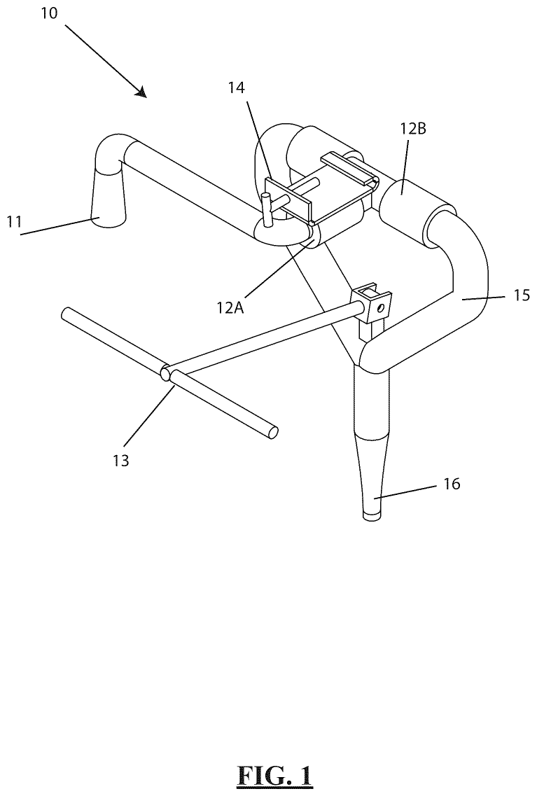

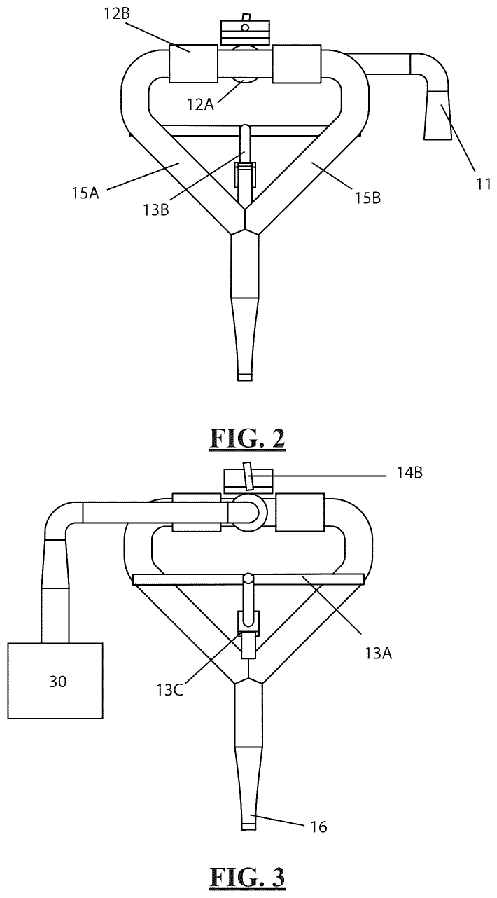

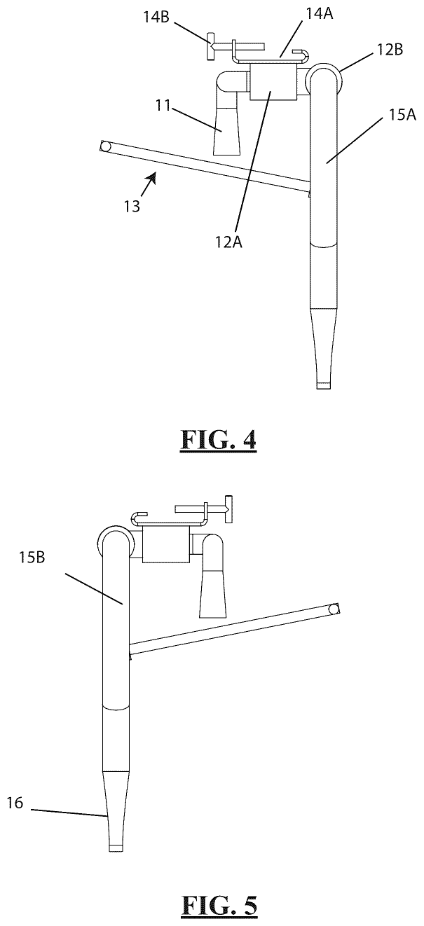

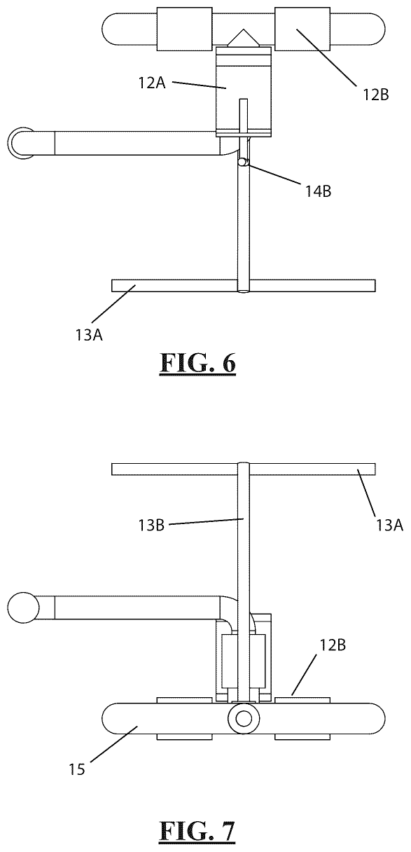

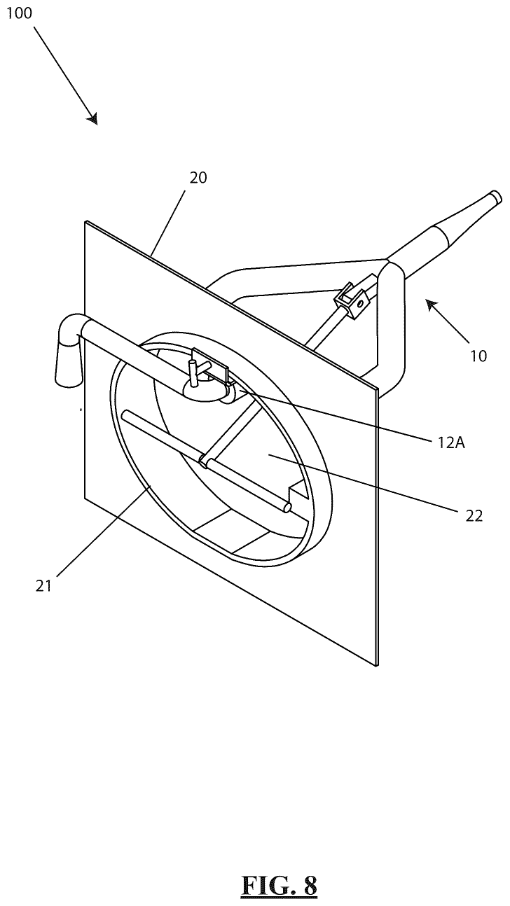

Referring to the drawings, wherein like reference characters designate like or corresponding parts throughout the several views, and referring particularly to FIGS. 1-13, it is seen that the present invention includes various embodiments of a water cannon system operable to clean the internal cavity of a storage tank.

The present invention concerns a water cannon system 10 operable to clean the internal cavity 22 of a storage tank 20, as shown in FIG. 8. The storage tank 20 may be a container having an access portal 21. The access portal 21 may allow access to the internal contents inside tank 20. The tank 20 may be for storage of wine, fermented liquids, beer, cider, distilled spirits, brine, dairy products, and other liquid materials.

The access portal 21 may include a door that nests or otherwise engages with a collar extending outwards from the internal cavity 22 of the tank 20. The collar may form a protruding, cylindrical interface serving as an entry point to the internal cavity 22 of the tank 20. The outward extension of the access door 21 may provide operators with a stable mounting surface to receive the water cannon system 10.

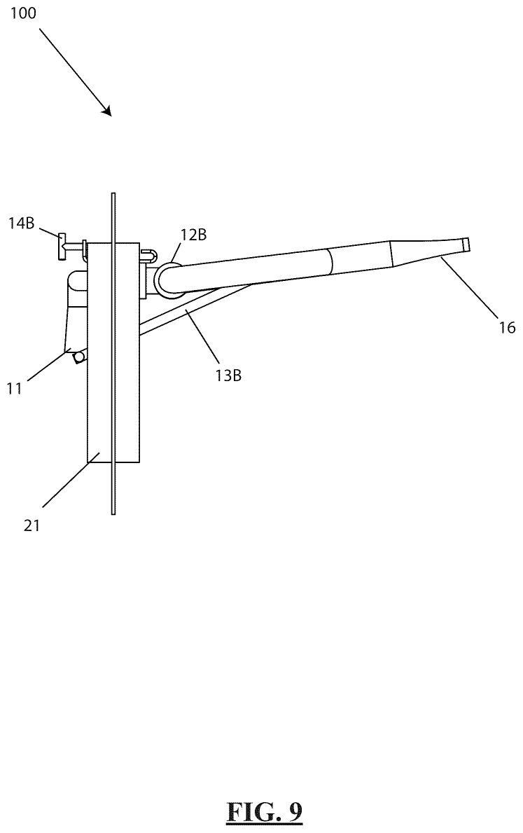

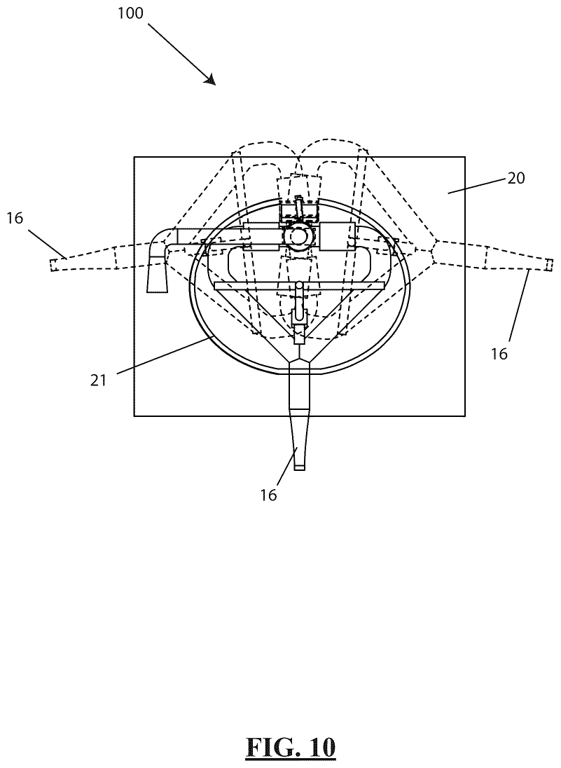

In some embodiments, operators may clean the internal cavity 22 of the storage tank 20 by first mounting the water cannon system 10 to the access portal 21. The water cannon system 10 may include a support bracket 14 with a slot 14A that engages with access door 21, as shown in FIGS. 8-9. The support bracket 14 may also include an adjustment mechanism 14B to securely lock the water cannon 10 in place with the access door 21. The adjustment mechanism 14B may be a screw, bolt, or clamp operable to be tightened or loosened by the operator to ensure a secure fit with the storage tank 20.

In some embodiments, the water cannon 10 may include a fluid conduit 11, first joint 12A, second joint 12B, handle 13, support bracket 14, output nozzle 16, and a cannon body 15, as shown in FIGS. 1-7. The handle 13 may be manipulated by an operator (not shown) standing outside of the access door 21. Operators may manipulate the handle 13 to point the output nozzle 16 towards all surfaces in the cavity 22. While using the cannon system 10, the operator may manipulate the handle 13 from outside the cavity 22, thereby avoiding entering the interior of the tank 20 in any manner.

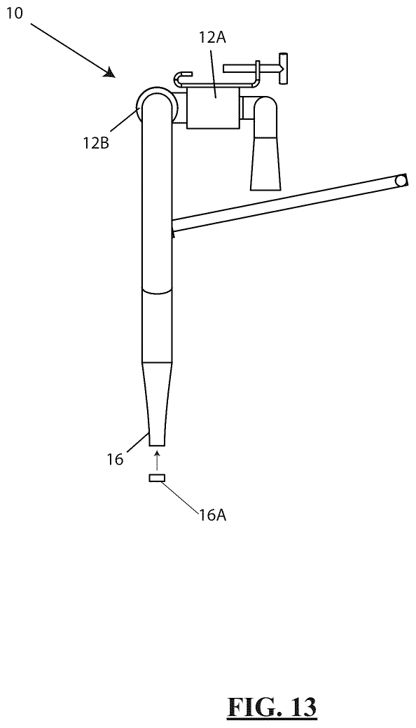

The input conduit 11 may be connected to an external water source 30 to receive water and the output nozzle 16 may spray water inside the cavity 22, as shown in FIG. 12. External water sources 30 may include pumps, municipal water supplies, water tanks, water trailers, reservoir systems, recycled water systems, and the like.

The water cannon system 10 may include a cannon body 15 having a pair of converging conduits 15A and 15B terminating at an output nozzle 16 operable to direct water flow inside the tank 20. In between the cannon body 15 and the input conduit 11 is a connection mechanism that includes first joint 12A and second joint 12B. The first joint 12A is operable to rotate about a horizontal axis perpendicular to a plane defined by access portal 21. The joint allows for barrel rotation of the cannon body 15 through the rotation of the handle 13, e.g., by an operator. The second joint 12B allows for pitch adjustment that can rotate the converging conduits 15A and 15B around the second joint 12B. The second joint 12B includes two fluid-tight, rotational connections in a t-joint arrangement: one between conduit 15A and a first side of the second joint 12B, and another conduit 15B and a second side of the second joint 12B. The combination of the first and second joints 12A and 12B allows the cannon body 15 to swivel about the access door 21 while maintaining a continuous flow of water. In some exemplary embodiments, the connection mechanism 12 may incorporate seals or bearings (not shown) to ensure smooth rotation and prevent leakage during operation.

The handle 13 may include a handlebar 13A attached to a connecting shaft 13B. At a distal end of the connecting shaft 13B is a securing bracket 13C that anchors the handle 13 to the cannon body 15. The handlebar 13A may extend from a proximal end (not shown) of the connecting shaft 13B and may include grips (not shown) to improve grip and ease manipulation of the handle 13 by an operator. Operators may control the cannon body 15 by manipulating the handlebar 13A.

The position of the cannon body 15 is adjusted based on movements from the handlebar 13A. Through the handlebar 13A, operators (not shown) may direct the output nozzle 16 towards all surfaces in the cavity 22. More specifically, as the operator moves the handlebar 13A, the connecting shaft 13B translates this movement towards the cannon body 15, allowing the output nozzle 16 to spray water at all surfaces in the cavity 22.

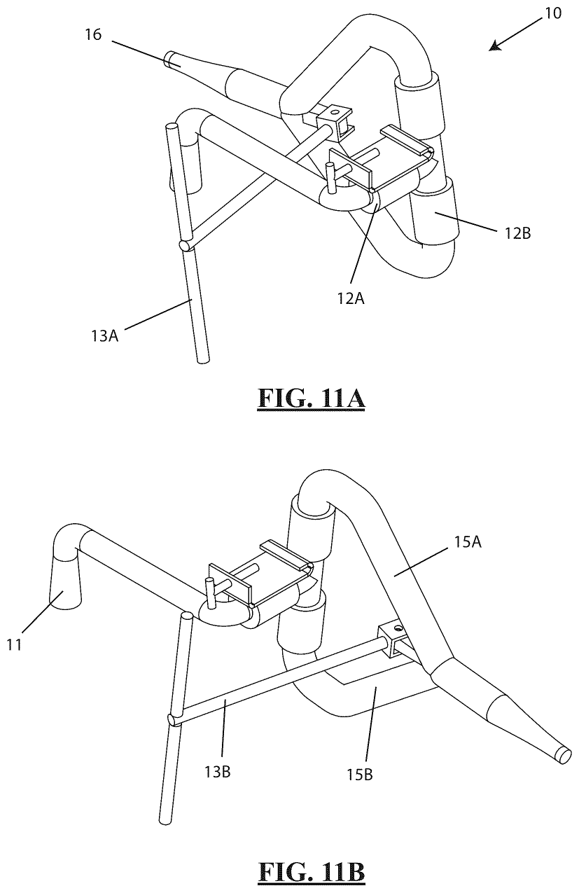

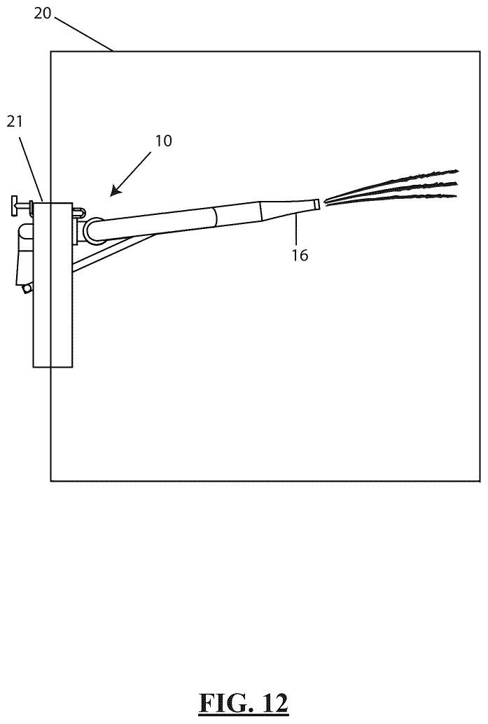

The first and second joints 12A and 12B may allow the operator to manipulate the handle 13 to angle the cannon body at any surface in the cavity 22 of tank 20. The first joint 12A apply barrel rotation to the cannon body 15 about an axis perpendicular to a plane relative to the access door 21, as shown in FIG. 10. The second joint 12B allows the cannon body 15 to be rotated around the second joint 12B to allow change in pitch to allow up and down angling of the cannon body 15 and side to side angling of the cannon body, as shown in FIGS. 11A-11B. For example, the second joint 12B and handle 13 may be operated to manipulate cannon body 15 at angles ranging from about 0 to about 120 degrees at any given rotational position of the first joint 12A. The cannon body 15 may be angled through the about 0 to about 120 degrees in an initial rotational position of the first joint 12A, and then the rotational angle of the first joint may be changed to address other surfaces of interior of the tank 20. This is shown, e.g., in FIGS. 11A and 11B. In FIG. 11A, a first rotational position of the first joint 12A is shown that allows the cannon body 15 to be horizontally swiveled between about a zero-angle pointing straight ahead and to angle of about 120° that can reach the interior surfaces of the tank 20 to the left of the access portal 21. In FIG. 11B, the first joint 12A has been rotated 180° relative to the first rotational position that allows the cannon body 15 to be horizontally swiveled between about a zero-angle pointing straight ahead and to angle of about 120° that can reach the interior surfaces of the tank 20 to the right of the access portal 21. Therefore, the water cannon 10 may direct water flow at all surfaces inside the cavity 22 through the rotation of the first and second joints 12A and 12B, providing comprehensive cleaning coverage of the tank 20.

The output nozzle 16 of the water cannon may spray water at a plurality of speeds and pressures. Operators may control the amount of water flow directed towards the internal cavity 22 by adjusting flow parameters (not shown) from the input pipe 11. In some exemplary embodiments, the output nozzle 16 may spray water at higher velocities to effectively clean the internal cavity 22 of any contaminants or additional residue. In other embodiments, the output nozzle 16 may deliver water at adjustable flow rates and pressures, allowing operators to adjust the cleaning intensity in the cavity 22.

In some exemplary embodiments, the output nozzle 16 may include interchangeable tips or adjustment mechanisms 16A to adjust spray patterns, as shown in FIG. 13. Examples of interchangeable tips or adjustments may include rotary attachments, diffusers, self-cleaning mechanisms, variable angle adapters, and the like. Examples of spray patterns may include focused jets, fan spray, rotating spray, oscillating spray, and the like.

In some embodiments, the water cannon 10 may be constructed of materials operable to avoid rust or corrosion and improve durability. Specifically, materials chosen for the water cannon 10 may not react with wine residue, cleaning agents, or water to produce additional contaminants affecting future batches of wine or other fluids. Examples of some materials include stainless steel, epoxy, electropolished finishes, aluminum, PTFE, Silicone, brass, titanium, and the like.

In some exemplary embodiments, the water cannon 10 may include an adapter (not shown) to accommodate other storage tanks 20. For example, storage tanks 20 may have different cavity sizes, different collar sizes, and the like. The adapter (not shown) may allow the water cannon 10 to mount to a plurality of different storage tanks 20.

In some embodiments, as shown in FIG. 8, there may be a water cannon system 100 with a water cannon system 10 mounted to a storage tank 20. Operators (not shown) may mount the water cannon 10 to the tank by engaging the support bracket 14 with the access door 21 of the tank 20. The interior cavity 22 of the tank 20 may be cleaned by moving the handlebar 13A in a plurality of directions. More specifically, operators (not shown) may manipulate handlebars 13A in a plurality of directions to clean a plurality of surfaces inside (e.g. cavity 22) the storage tank 20.

The water cannon 10 may be mounted to the storage tank 20 through the access door 21. To mount the water cannon 10, the adjustment mechanism 14B may be loosened to accommodate for the access door 21. Then, the slot 14A of the support bracket may engage with the access door 21. The adjustment mechanism 14B may be tightened to secure the cannon 10 to the tank 20. An external water source 30 may be connected to the input conduit 11 of the cannon 10. The operator may open a valve on the external water source 30 to initiate water flow, directing it towards the output nozzle 16. Using the handlebar 13A, operators may position the nozzle 16 towards a plurality of surfaces in the cavity 22 of the storage tank 20, thereby cleaning all surfaces within the tank 20.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A water cannon for cleaning a storage tank, the cannon comprising:
a. a support bracket operable to engage with an access door of said storage tank; and
b. a cannon body having an output nozzle that is operable to direct a flow of water;
c. a connection mechanism operable to swivel said cannon body with at least two degrees of freedom;
d. a handle connected to said cannon body;
wherein an operator can manipulate said handle to direct said output nozzle towards a plurality of surfaces inside a cavity of said storage tank while remaining entirely outside said access door of said storage tank.

2. The water cannon of claim 1, wherein said support bracket includes a slot that is operable to engage with said access door.

3. The water cannon of claim 2, wherein said support bracket includes an adjustment mechanism for securing said water cannon to said access door.

4. The water cannon of claim 1, further comprising an input conduit operable to receive fluid from an external source.

5. The water cannon of claim 1, wherein said output nozzle includes a removable and replaceable tip that may receive interchangeable tips that are operable to produce a plurality of spray patterns.

6. The water cannon of claim 1, wherein said operator manipulates said handlebar to swivel said cannon body about a horizontal first axis and a second axis perpendicular to said first axis.

7. The water cannon of claim 1, wherein said connection mechanism includes two rotational joints with perpendicular axes, a first joint having a first axis of rotation that is horizontal, and a second joint distal to said first joint.

8. The water cannon of claim 7, wherein said cannon body is operable to swivel using said first and second joints to direct said output nozzle to all surfaces within said storage tank.

9. The water cannon of claim 1, wherein said first joint has a rotational range of at least 270° and said second joint has a rotational range of at least 90°.

10. A method for cleaning a storage tank, the method comprising:
a. providing a water cannon having an input conduit, a support bracket, a cannon body, a connection mechanism positioned in between said input conduit and said cannon body, a handle having a connecting shaft connected to said cannon body, and an output nozzle; and
b. providing a storage tank having an access door;
c. engaging said support bracket with a frame of said access door; and
d. manipulating said handle to swivel said cannon body about an axis relative to said access door to clean a plurality of surfaces within said storage tank.

11. The method of claim 10, wherein said connection mechanism includes two rotational joints with perpendicular axes, a first joint having a first axis of rotation that is horizontal, and a second joint distal to said first joint.

12. The method of claim 11, wherein said cannon body is operable to swivel using said first and second joints to direct said output nozzle to all surfaces within said storage tank.

13. The method of claim 11, wherein said first joint has a rotational range of at least 270° and said second joint has a rotational range of at least 90°.

14. The method of claim 10, wherein manipulating said handle to swivel said cannon body includes rotating said connection mechanism about a horizontal first axis and a second axis perpendicular to said first axis.

15. A system for cleaning a storage tank, the system comprising:
a water cannon having an input conduit, a support bracket, a cannon body having an output nozzle operable to direct liquid flow, a connection mechanism positioned in between said input conduit and said cannon body, a handle having a connecting shaft extending from a handle joint, said handle positioned outside of an access door of said storage tank,
wherein said slot of said support bracket engages with said access door and an operator standing outside of said access door manipulates said handle to swivel said cannon body about a horizontal first axis and a second axis perpendicular to said first axis to clean a plurality of surfaces within said storage tank.

16. The system of claim 15, wherein said input conduit is operable to couple to a water source.

17. The system of claim 15, wherein said connection mechanism includes two rotational joints with perpendicular axes, a first joint having a first axis of rotation that is horizontal, and a second joint distal to said first joint.

18. The system of claim 15, wherein said cannon body is operable to swivel using said first and second joints to direct said output nozzle to all surfaces within said storage tank.

19. The system of claim 15, wherein said first joint has a rotational range of at least 270° and said second joint has a rotational range of at least 90°.

20. The water cannon of claim 15, wherein said support bracket comprises an adapter that is operable to mount to a plurality of different storage tanks.

21-96. (canceled)
